(19) United States
(12) Patent Application Publication
(10) Pub. No.: US 2011/0205879 A1
(43) Pub. Date: Aug. 25, 2011

(54) OPTICAL PICK-UP DEVICE AND METHOD FOR MANUFACTURING THE SAME

(75) Inventors: Masahito OGATA, Suginami-ku (JP); Yoshio NOISHIKI, Saitama-shi (JP); Ryoichi KAWASAKI, lsesaki-Shi (JP)

(73) Assignees: SANYO Electric Co., Ltd., Moriguchi-shi (JP); SANYO Optec Design Co., Ltd., Bunkyo-ku (JP)

(21) Appl. No.: 13/032,225

(22) Filed: Feb. 22, 2011

(30) Foreign Application Priority Data
Feb. 23, 2010 (JP) 2010-037307

(51) Int. Cl. G11B 7/135

(52) U.S. Cl. 369/112.04; G9B/7.112

(57) ABSTRACT

Provided are an optical pick-up device which can appropriately correct an optical path of a laser beam emitted from a light-emitting chip arranged with a mounting error, and a method of manufacturing the same. An optical pick-up device includes: a first light-emitting chip and a second light-emitting chip which emit laser beams having predetermined wavelengths; a PDIC which receives the laser beams emitted from the first and the second light-emitting chips; and a first optical correction component and a second optical correction component provided between the PDIC and the light-emitting chips. The first and the second optical correction components incline a first laser beam by diffraction, while transmitting a second laser beam and a third laser beam without inclining these beams. With the diffraction of the first laser beam by these two correction components, the optical path of the first laser beam is corrected to a predetermined position.

### BACKGROUND OF THE INVENTION

1. Field of the Invention

The present invention relates to an optical pick-up device and a method of manufacturing the same, particularly to an optical pick-up device including multiple light-emitting chips each emitting a laser beam and to a method of manufacturing the same.

2. Description of the Related Art

Optical pick-up devices supporting multiple types of optical recording media are devised in various ways for size reduction, weight reduction, and other purposes. For example, one of such optical pick-up devices employs an objective lens compatible with a large number of laser wavelengths. Another one of such optical pick-up devices employs a laser device in which multiple laser diodes (light-emitting chips) with different wavelengths are packaged as a single unit.

Such inclusion of multiple laser diodes with different wavelengths in the laser device as a single package reduces the number of components of an optical pick-up device, thereby achieving cost reduction (see Japanese Patent Application Publication No. 2002-163837, for example).

### SUMMARY OF THE INVENTION

The laser device including multiple light-emitting chips therein, however, involves a mounting error between the multiple light-emitting chips, which occurs upon mounting of the multiple light-emitting chips. Because of the error, distances between light sources included in the respective light-emitting chips are made ununiform. The mounting error which occurs in the step of mounting a light-emitting chip is generally in a range of about ±20 μm and if an error within this range occurs between the light sources, the error would have a serious adverse effect on the optical pick-up device.

A light-emitting chip emitting a BD laser beam, in particular, has a substrate made of a material different from the one for a light-emitting chip emitting a DVD laser beam or a CD laser beam. Because of this, an optical pick-up device supporting these media at least requires a light-emitting chip for BD and a light-emitting chip for DVD and CD. Thus, the mounting error occurring upon mounting of the light-emitting chips may lead to deterioration in performance of the optical pick-up device, such as deterioration in reading or writing information from or into media, unless any measure is taken to accommodate the mounting error.

The present invention has been made in view of the above problems. The main purpose of the present invention is to provide an optical pick-up device which enables appropriate correction of an optical path of a laser beam emitted from a light-emitting chip mounted with a mounting error and to provide a method of manufacturing the same.

An optical pick-up device of the present invention is an optical pick-up device which emits a laser beam to an optical recording medium and detects the laser beam reflected back from the optical recording medium, the optical pick-up device comprising: a laser device which includes a first light-emitting chip and a second light-emitting chip, the first light-emitting chip emitting a first laser beam from a first light source, the second light-emitting chip emitting a second laser beam from a second light source, the second laser beam having a wavelength different from the first laser beam; a first optical correction component which is disposed in the course of optical paths of the first and the second laser beams, the first optical correction component inclining a travel direction of the first laser beam toward the second laser beam and transmitting the second laser beam; a second optical correction component which is disposed in the course of the optical paths of the first and the second laser beams at a position farther from the laser device than the first optical correction component is, the second optical correction component correcting the travel direction of the first laser beam in such a way that the first laser beam travels parallel to an optical axis of the optical pick-up device, and transmitting the second laser beam; and a light receiving chip including a first light reception region which receives the first laser beam and the second laser beam.

A method of manufacturing an optical pick-up device of the present invention is a method of manufacturing an optical pick-up device which emits a first laser beam and a second laser beam to an optical recording medium and detects the first and the second laser beams reflected back from the optical recording medium, the second laser beam having a wavelength different from a wavelength of the first laser beam, the method comprising: a first step of disposing a first optical correction component in the course of optical paths of the first and the second laser beams and disposing a second optical correction component in the course of the optical paths of the first and the second laser beams at a position farther from a laser device than the first optical correction component is, the first optical correction component inclining a travel direction of the first laser beam toward the second laser beam and transmitting the second laser beam, the second optical correction component correcting a travel direction of the first laser beam in such a way that the first laser beam travels parallel to an optical axis of the optical pick-up device and transmitting the second laser beam; and a second step of positioning the laser device and a light receiving chip, the laser device including a first light-emitting chip emitting the first laser beam from a first light source and a second light-emitting chip emitting the second laser beam from a second light source, the light receiving chip including a light reception region on which the second laser beam is incident.

According to the present invention, even in a case where a first light-emitting chip emitting a first laser beam and a second light-emitting chip emitting a second laser beam are arranged with a mounting error, two optical correction components provided in the course of optical paths of the first laser beam and the second laser beam correct the optical path of the first laser beam appropriately. Thus, the mounting error between the first and the second light-emitting chips can be appropriately absorbed by using the optical correction components.

Further, since the optical correction components can bring the optical path of the first laser beam to match with the optical path of the second laser beam, it is possible to detect both the first laser beam and the second laser beam by a single light reception region. In other words, only a single laser device and a single light receiving chip are required even for an optical pick-up device which employs multiple laser beams. This enables reduction in the number of components in the optical pick-up device, thereby achieving cost reduction.

Furthermore, the effects of the optical correction components described above can bring the optical path of the first laser beam closer to the optical axis of the optical pick-up device. This improves image height characteristics of the first laser beam.

### BRIEF DESCRIPTION OF THE DRAWINGS

FIGS. 1A to 1C are diagrams illustrating an optical pick-up device of preferred embodiments of the invention. FIG. 1A is a cross-sectional view illustrating a laser device included in the optical pick-up device; FIG. 1B is a cross-sectional view illustrating a configuration in which light-emitting chips are mounted; and FIG. 1C is a diagram illustrating a part of a configuration of the optical pick-up device.

FIG. 2 is a diagram illustrating an entire configuration of the optical pick-up device of the preferred embodiments of the invention.

FIGS. 3A and 3B are diagrams illustrating a configuration of an optical pick-up device of another mode of the preferred embodiments of the invention. FIG. 3A is a cross-sectional view, while FIG. 3B is a diagram illustrating a principal portion.

FIG. 4 is a flowchart illustrating a method of manufacturing an optical pick-up device, of the preferred embodiments of the invention.

FIG. 5 is a diagram illustrating the method of manufacturing an optical pick-up device, of the preferred embodiments of the invention.

### DESCRIPTION OF THE INVENTION

### First Embodiment

### Configuration of Optical Pick-Up Device

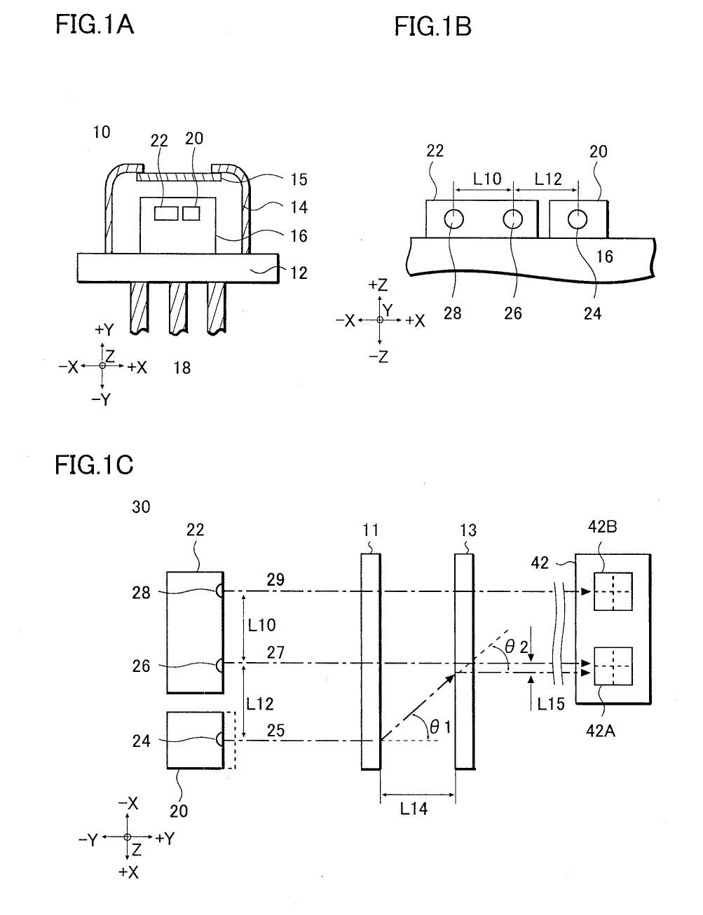

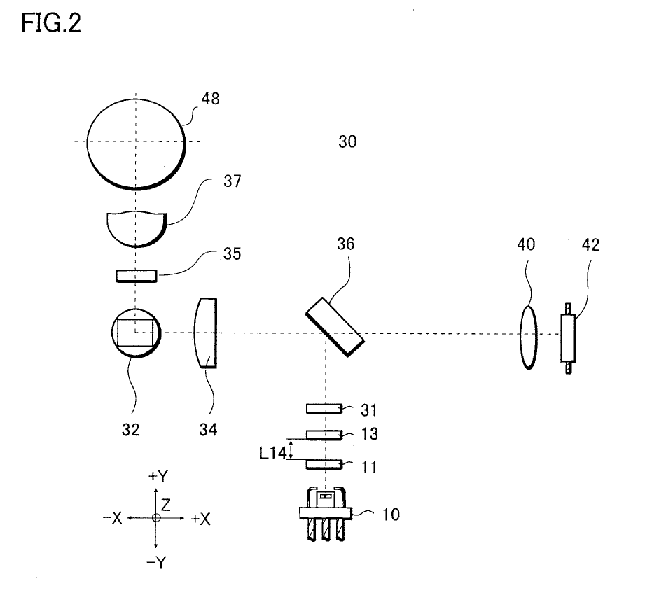

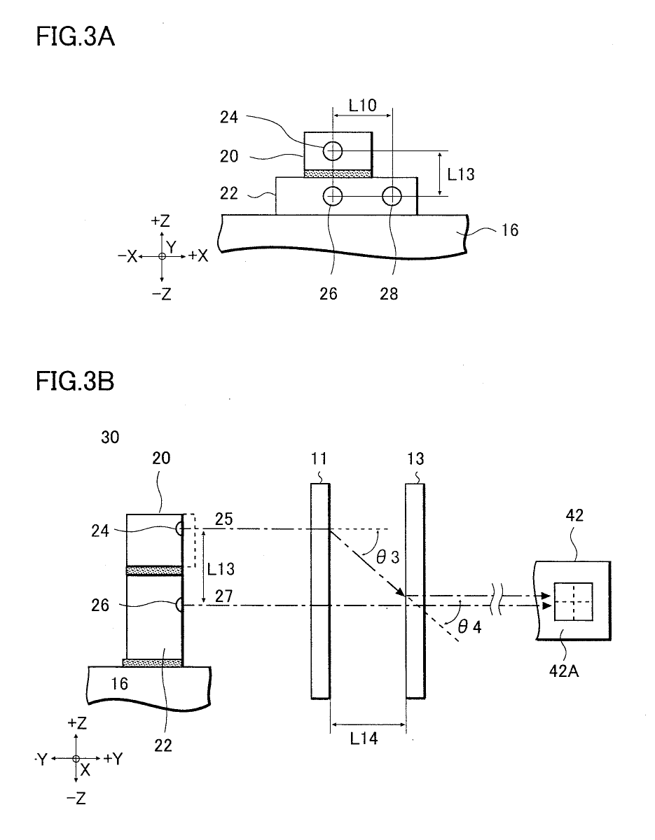

With reference to FIGS. 1A to 1C, 2, 3A, and 3B, a configuration of an optical pick-up device 30 according to a first embodiment will be described. FIG. 1A is a cross-sectional view illustrating a laser device 10 incorporated in the optical pick-up device 30; FIG. 1B is a cross-sectional view illustrating light-emitting chips included in the laser device 10; and FIG. 1C is a diagram illustrating a part of the optical pick-up device 30. FIG. 2 is a diagram illustrating an entire configuration of the optical pick-up device 30. FIGS. 3A and 3B are diagrams illustrating an optical pick-up device 30 according to another mode of the preferred embodiments of the invention.

This embodiment will be described by using an X axis, a Y axis, and a Z axis which are orthogonal to one another. The Y axis is an axis parallel to a direction in which a laser beam travels after being emitted from the laser device 10. The X axis is an axis parallel to a direction along which a first light-emitting chip 20 and a second light-emitting chip 22 are arranged in a row. The Z axis is an axis extending in a direction perpendicularly penetrating the sheet (see FIG. 1A). Multiple light sources included in the first and the second light-emitting chips 20 and 22 are arranged on a Z-X plane.

With reference to FIG. 1A, a configuration of the laser device 10 incorporated in the optical pick-up device 30 according to this embodiment will be described. The laser device 10 is a CAN package and mainly includes: an almost-disc-shaped substrate portion 12; a plate-like stem 16 fixedly attached to an upper surface of the substrate portion 12; two light-emitting chips (a first light-emitting chip 20 and a second light-emitting chip 22) mounted on the stem 16; a jacket portion 14 which covers the first light-emitting chip 20 and the second light-emitting chip 22; a cover 15 formed of a glass plate which covers an opening portion provided in an upper portion of the jacket portion 14; and terminal portions 18 which are electrically connected to the first and the second light-emitting chip 20 and 22 and are led to the outside.

The laser device 10 emits a laser beam having a predetermined wavelength from the first light-emitting chip 20 or the second light-emitting chip 22 on the basis of electric power supplied from the outside via the terminal portions 18. The emitted laser beam passes through the cover 15 provided on the upper portion of the jacket portion 14 and is emitted to the outside.

More specifically, the laser device 10 emits three laser beams with different wavelengths which are each used for reading or writing information from or into respective discs. To be more specific, the three laser beams are: a first laser beam used for reading or writing information from or into a disc (optical recording medium) of a BD (Blu-ray Disc) standard or of a HD-DVD (High-Definition Digital Versatile Disc) standard; a second laser beam used for reading or writing information from or into a disc of a DVD (Digital Versatile Disc) standard; and a third laser beam used for reading or writing information from or into a disc of a CD (Compact Disc) standard. Although the three laser beams with different wavelengths are emitted from two light-emitting chips here, the type of emitted laser beams may be two, four, or more. In the preferred embodiments of the invention, multiple light-emitting chips are mounted inside the laser device 10.

In this respect, the first laser beam is a violet light and is in a wavelength range between 400 nm and 420 nm, the second laser beam is a red light and in a wavelength range between 645 nm and 675 nm, and the third laser beam is an infrared light and in a wavelength range between 765 nm and 805 nm.

In FIG. 1B, the first light-emitting chip 20 and the second light-emitting chip 22 are mounted on a mounting surface, or the main surface of the stem 16, with a predetermined distance between each other. The first light-emitting chip 20 and the second light-emitting chip 22 are transported by a collet provided with an attachment pad in a way that their upper surfaces are attached to the collet. Then, the first light-emitting chip 20 and the second light-emitting chip 22 are fixedly attached to the mounting surface by an adhesive.

The first light-emitting chip 20 is a laser diode made of a semiconductor such as zinc selenide or gallium nitride, and is fixedly attached to an upper surface of the stem 16 by an adhesive such as a conductive paste. A first light source 24 is provided on an end surface of the first light-emitting chip 20. The first light source 24 emits a first laser beam.

A second light-emitting chip 22 is a laser diode made of a semiconductor such as silicon, and is fixedly attached to the upper surface of the stem 16 by a conductive adhesive, in the same manner as the first light-emitting chip 20 is. Two light sources (a second light source 26 and a third light source 28) are provided on an end surface of the second light-emitting chip 22. The second light source 26 emits a second laser beam and the third light source 28 emits a third laser beam. A distance L10 between the second light source 26 and the third light source 28 is generally designed to be 110 μm. Allowing for the error (±1 μm) occurring at the manufacturing, the distance L10 falls within a range between 109 μm to 111 μm both inclusive, for example. Since the second light source 26 and the third light source 28 are both formed in the second light-emitting chip 22, the distance L10 therebetween has high accuracy.

In FIG. 1B, the third light source 28 is provided on the left side, in the drawing, in the second light-emitting chip 22 and the second light source 26 is provided on the right side therein. This positional relationship therebetween, however, may be reversed.

The first light-emitting chip 20 and the second light-emitting chip 22 are fixedly attached to the main surface of the stem 16 while their end surfaces on which the first to the third light sources 24, 26, and 28 are provided face in the Y direction. The end surface of the first light-emitting chip 20 on which the first light source 24 is provided is arranged to be flush with the end surface of the second light-emitting chip 22 on which the second light source 26 and the third light source 28 are provided.

The first light-emitting chip 20 is disposed to be adjacent to the second light-emitting chip 22, on a second light source 26 side of the second light-emitting chip 22. In this respect, the first light-emitting chip 20 may otherwise be disposed to be adjacent to the second light-emitting chip 22, on a third light source 28 side of the second light-emitting chip 22.

As in the case of the distance L10, a distance L12 between the first light source 24 provided in the first light-emitting chip 20 and the second light source 26 provided in the second light-emitting chip 22 is designed to be 110 μm. The distance L12, however, has lower accuracy than does the distance L10. The distance L10 has high accuracy owing to the accuracy of its previous processing (diffusion processing), while the distance L12 has lower accuracy because the accuracy is dependent on the accuracy of a bonder used for fixedly bonding the first and the second light-emitting chips 20 and 22. Therefore, the distance L12 allows for an error of +20 μm. Specifically, the distance L12 is in a range between 90 μm to 130 μm, both inclusive.

FIG. 1C is a diagram illustrating a part of the optical pick-up device 30 extracted for the purpose of clarifying the main point of this embodiment. As illustrated in FIG. 1C, the optical pick-up device 30 includes: the first light-emitting chip 20 and the second light-emitting chip 22 which emit laser beams having predetermined wavelengths, respectively; a PDIC 42 (light receiving chip) which receives laser beams emitted from the first light-emitting chip 20 and the second light-emitting chip 22; and a first optical correction component 11 and a second optical correction component 13 which are disposed between the PDIC 42 and the first and the second light-emitting chips 20 and 22. The embodied optical pick-up device 30 includes various optical components besides these components, but the detailed configuration of the optical pick-up device 30 will be described later with reference to FIG. 2.

As has been described, since being mounted separately, the first light-emitting chip 20 and the second light-emitting chip 22 are relatively positioned with respect to each other with an error of about ±20 μm occurring at the mounting. This mounting error leads directly to the error between the first light source 24 provided in the first light-emitting chip 20 and the second light source 26 provided in the second light-emitting chip 22 as well as to the error between the first light source 24 provided in the first light-emitting chip 20 and the third light source 28 provided in the second light-emitting chip 22. In view of this, it is not easy for light-receiving areas fabricated in the PDIC 42 formed of a single semiconductor chip to receive the laser beams emitted from the first to the third light sources 24, 26, and 28.

In this embodiment, an optical correction component which changes a travel direction of a laser beam with a specific wavelength is provided in the course of an optical path of the laser beam. Specifically, a first optical correction component 11 and a second optical correction component 13 are provided in the course of an optical path of a laser beam. The first optical correction component 11 is disposed upstream of the second optical correction component 13 in the travel direction of each laser beam. Thus, each laser beam passes through the first optical correction component 11, and then passes through the second optical correction component 13.

The first optical correction component 11 inclines the optical path of a first laser beam 25 which has the shortest wavelength by diffracting the first laser beam 25. Meanwhile, the first optical correction component 11 transmits a second laser beam 27 and a third laser beam 29 as they are, basically without diffracting the second and the third laser beams 27 and 29 to change their travel directions, the second and the third laser beams 27 and 29 having longer wavelengths than the first laser beam 25 has. Specifically, the first optical correction component 11 inclines the travel direction of the first laser beam 25 (at an angle θ1) in such a manner that the first laser beam 25 comes closer to the second laser beam 27 by diffracting the first laser beam 25 having travelled parallel to an optical axis of the optical pick-up device 30. Here, the first to the third laser beams 25, 27, and 29 emitted from the first and the second light-emitting chips 20 and 22 are in parallel to the optical axis of the optical pick-up device 30. This optical axis is superposed on the second laser beam 27, for example.

In the same manner as the first optical correction component 11 does, the second optical correction component 13 inclines the first laser beam 25 by diffracting the first laser beam 25 while transmitting the second laser beam 27 and the third laser beam 29 as they are, without inclining the second and the third laser beams 27 and 29. The second optical correction component 13 inclines the first laser beam 25 in the direction reverse to the inclination by the first optical correction component 11. Moreover, an angle θ2 at which the second optical correction component 13 inclines the first laser beam 25 by diffraction effect is the same as the angle θ1 at which the first optical correction component 11 inclines the first laser beam 25. For this reason, the optical path of the first laser beam 25 having been inclined with respect to the optical axis of the optical pick-up device 30 is made parallel to the optical axis with the diffraction operation by the second optical correction component 13.

The optical path of the first laser beam 25 having passed through the second optical correction component 13 is superposed on the optical path of the second laser beam 27. Even if these optical paths are not superposed on each other, a distance L15 between these optical paths of the first laser beam 25 and the second laser beam 27 is 5 μm or smaller.

A distance L14 between the first optical correction component 11 and the second optical correction component 13 is set to such a distance as to allow the first laser beam 25 to come close enough to the second laser beam 27. It is ideal that the optical path of the first laser beam 25 having been transmitted by the second optical correction component 13 is superposed on the optical path of the second laser beam 27. With this setting, it is possible to detect the first and the second laser beams 25 and 27 by the same first light reception region 42A. Even if the optical paths of the first and the second laser beams 25 and 27 are not superposed on each other, the distance L15 between these optical paths of the first laser beam 25 and the second laser beam 27, which are apart from each other in the X direction, is 5 μm or smaller, as described above. Thus, the single first light reception region 42A can receive both the first and the second laser beams 25 and 27.

The PDIC 42 includes two light reception regions (the first light reception region 42A and a second light reception region 42B). The PDIC 42 detects a signal by receiving each laser beam, and performs a focus servo process and a tracking servo process.

Servo processes performed by use of the PDIC 42 include: a focus servo process for focusing a laser beam on a recording surface of a disc in a vertical direction; and a tracking servo process for positioning a laser beam in a radial direction in such a way that the laser beam can follow a recording track of a disc. As for the focus servo process, an astigmatism method or a differential astigmatism method can be employed. As for the tracking servo process, a push-pull method, a differential push-pull method, an inline DPP method, or a three-beam method can be employed. Here, one light reception region is provided for each laser beam. In a case, for example, where the differential push-pull method is employed as the tracking servo process and the differential astigmatism method is employed as the focus servo method, however, each of the first light reception region 42A and the second light reception region 42B of the PDIC 42 is formed of three light reception region sections so as to correspond to three laser beams separated by a diffraction grating 31.

It is a common practice to provide two PDICs for receiving laser beams emitted from the first light-emitting chip 20 and the second light-emitting chip 22 provided as light sources in a hybrid manner. In this embodiment, however, the first laser beam 25 emitted from the first light-emitting chip 20 and the second laser beam 27 emitted from the second light-emitting chip 22 are received by the first light reception region 42A alone by superposing the first laser beam 25 and the second laser beam 27 on each other by use of the first and the second optical correction components 11 and 12 as described above. It is thus possible for the single PDIC 42 to receive laser beams emitted from two light-emitting chips mounted in a hybrid manner.

The mounting error between the light-emitting chips may be of any length within a predetermined value (±20 for example). Even with the mounting error, if the distance L14 between the first optical correction component 11 and the second optical correction component 13 is adjusted, it is possible to correct the optical path of the first laser beam 25 emitted from the first light-emitting chip 20 so that the optical path can be positioned at a predetermined position.

The optical axis of the optical pick-up device 30 is disposed so as to coincide with the optical path of the second laser beam 27 or the optical path of the third laser beam 29. Since the first laser beam 25 is corrected to come close to the second laser beam 27, the optical path of the first laser beam 25 comes close to the optical axis. This is advantageous to improve the image height characteristics of the first laser beam 25.

Here, in FIG. 1C, the end surface of the first light-emitting chip 20 on the +Y direction side where the first light source 24 is provided is disposed to be flush, in the Y axis direction, with the end surface of the second light-emitting chip 22 on the +Y direction side where the second light source 26 and the third light source 28 are provided. However, the +Y-direction-side end surface of the first light-emitting chip 20 may be disposed to protrude in the +Y direction from the +Y-direction-side end surface of the second light-emitting chip 22. This disposition is illustrated by a dotted line in FIG. 1C.

Unless any measure is taken, the optical path of the first laser beam 25 inclined in the course by the optical correction component becomes longer than the optical paths of the other laser beams. This may adversely affect the performance of the optical pick-up device 30. If the end surface of the first light-emitting chip 20 protrudes in the +Y direction which is the travel direction of the laser beam, the length of the optical path of the first laser beam 25 is made equivalent to the other optical paths, thereby making this problem less likely to occur.

Specifically, jitter occurs in the PDIC 42 if optical paths of laser beams are different in length. Further, the position of the PDIC 42 in the Y direction at which the optimum amplitude is obtained is offset in the Y direction attributable to the ununiform lengths of the optical paths. This leads to defocusing of the laser beams. It is a common practice that an electrical offset is applied to a focus servo circuit for handling such a problem. On the other hand, in this embodiment, the position of the first light source 24 is shifted in the +Y direction to address the ununiform lengths of the optical paths, as has been described above. This embodiment is thus advantageous in that the offset of a servo signal is reduced.

As shown in FIG. 2, the configuration of the optical pick-up device 30 will be described in detail below. The optical pick-up device 30 reads or writes information from or into a disc 48 by emitting a laser beam to the disc 48 and then detecting the laser beam which is a return light reflected back from an information recording surface of the disc 48. The optical pick-up device 30 is used by being installed in an information recording reproducing system, such as a disc reproducing system.

Specifically, the optical pick-up device 30 mainly includes: the laser device 10; the first optical correction component 11 and the second optical correction component 13 which respectively correct the optical paths of the laser beams emitted from the laser device 10; the diffraction grating 31; a semitransparent mirror 36; a collimate lens 34; a reflecting mirror 32; a quarter wave plate 35; an objective lens 37; an anamorphic lens 40; and the PDIC 42.

The laser device 10, the first optical correction component 11, the second optical correction component 13, and the PDIC 42 have been described in detail with reference to FIGS. 1A to 1C.

The diffraction grating 31 separates each laser beam into a zero order diffracted light, a positive first order diffracted light, and a negative first order diffracted light, the laser beam having been emitted from the laser device 10 and having passed through the first and the second optical correction components 11 and 13.

The semitransparent mirror 36 reflects, in the −X direction, the laser beam having been emitted from the laser device 10 and having passed through the diffraction grating 31 and the other components. In addition, the semitransparent mirror 36 transmits, in the +X direction, the laser beam (return light) reflected back from the disc 48. The return light reflected back from the disc 48 is once converted into a circularly polarized light with an effect of the quarter wave plate 35, and then converted back to a linearly polarized light. For this reason, the return light is polarized in a direction different from the direction in which the return light has been polarized just after being emitted from the laser device 10, and thus passes through in the +X direction.

The collimate lens 34 collimates the laser beam reflected off the semitransparent mirror 36. In addition, the collimate lens 34 is provided to be movable in the X direction. Making the collimate lens 34 movable enables to correct deterioration in optical characteristics of the objective lens 37 due to the temperature change. This also corrects spherical aberration which occurs due to variation in thickness of a cover layer which covers an information recording layer of the disc 48 or due to variation in thickness of a cover in an information recording layer of each of multi-layer structured optical recording media.

The laser beam having passed through the collimate lens 34 is incident on the reflecting mirror 32, and the reflecting mirror 32 is configured to reflect, in the +Y direction, the laser beam having been traveling in the −X direction.

The quarter wave plate 35 is configured to convert the laser beam reflected off the reflecting mirror 32, from the linearly polarized light into the circularly polarized light as well as to conversely convert the return light reflected back from the disc 48, from the circularly polarized light into the linearly polarized light.

The objective lens 37 is provided right above the reflecting mirror 32, and is configured to focus the laser beam raised in the Y direction by the reflecting mirror 32, to a signal recording surface of the disc 48. In this embodiment, the objective lens 37 is shared by the first laser beam 24, the second laser beam 26, and the third laser beam 28 which are respectively used for recording and reproduction of BD, DVD, and CD.

The anamorphic lens 40 adds astigmatism to the laser beam having passed through the semitransparent mirror 36 and going to be incident on the PDIC 42.

Next, reading and writing operations of an optical pick-up device 30 configured in the above manner will be described. Although a laser device 10 emits three laser beams with different wavelengths (a first laser beam 25, a second laser beam 27, and a third laser beam 29, which are shown in FIG. 1C), the optical paths for the three laser beams are the same, as will be described below. Moreover, the operation described below is applied to both reading and writing.

Firstly, the first laser beam 25 emitted from a first light source 24 of the laser device 10 passes through a first optical correction component 11 and a second optical correction component 13. In this respect, the optical path of the first laser beam 25 having the shortest wavelength is corrected to be positioned at a predetermined position by being diffracted by the first optical correction component 11 and the second optical correction component 13, and is thus superposed on the optical path of the second laser beam 27. On the other hand, the second laser beam 27 and the third laser beam 29 which have longer wavelengths are transmitted by the first optical correction component 11 and the second optical correction component 13 without being diffracted by the first optical correction component 11 and the second optical correction component 13. The detail has been given above with reference to FIGS. 1A to 1C.

The first laser beam 25 having passed through the first optical correction component 11 and the second optical correction component 13 then passes through a diffraction grating 31, where the first laser beam 25 is separated into a zero order diffracted light, a positive first order diffracted light, and a negative first order diffracted light. The separation of the first laser beam 25 is made so that a PDIC 42 can perform the tracking servo process and the focus servo process.

The first laser beam 25 having passed through the diffraction grating 31 is reflected in the −X direction by a semitransparent mirror 36. Then the first laser beam 25 is collimated by a collimate lens 34, is reflected by a reflecting mirror 32, and thus travels in the vertical direction with respect to a disc 48 (in the +Y direction).

Further, the first laser beam 25 passes through a quarter wave plate 35, where the first laser beam 25 is converted into a circularly polarized light, and then is focused on a signal recording surface of the disc 48 with a refraction effect and the diffraction effect of an objective lens 37.

The first laser beam 25 (return light) reflected back from the signal recording surface of the disc 48 passes through the objective lens 37, the quarter wave plate 35, the reflecting mirror 32, and the collimate lens 34, and arrives at the semitransparent mirror 36. In this procedure, the first laser beam 25 being the return light is converted from the circularly polarized light into the linearly polarized light when passing through the quarter wave plate 35.

The anamorphic lens 40 adds astigmatism for the focus servo process to the first laser beam 25 having passed through the semitransparent mirror 36, and the first laser beam 25 arrives at the PDIC 42. The PDIC 42 reads information and performs the focus servo process and the tracking servo process.

The configuration and the operation of the optical pick-up device 30 have been given so far.

Now, with reference to FIGS. 3A and 3B, a configuration of an optical pick-up device 30 of another mode will be described. FIG. 3A is a cross-sectional view illustrating a configuration in which light-emitting chips are mounted while FIG. 3B is a diagram illustrating a part of the optical pick-up device 30. The schematic configuration of the optical pick-up device 30 shown in FIGS. 3A and 3B is the same as the one shown in the first embodiment except for a difference in a form of mounting a first light-emitting chip 20 and a second light-emitting chip 22.

In FIG. 3A, two light-emitting chips are mounted on an upper surface, which is a mounting surface, of a stem 16, in a stacked state. Specifically, a second light-emitting chip 22 is fixedly attached to the upper surface of the stem 16 by a bonding agent, and a first light-emitting chip 20 is fixedly attached to an upper surface of the second light-emitting chip 22 by a bonding agent. As a bonding agent for fixedly bonding each light-emitting chip, an insulating bonding agent such as an epoxy resin or a conductive bonding agent such as an Ag paste is employed, the bonding agent prepared in a sheet or liquid form.

A distance L10 between a second light source 26 and a third light source 28 provided on the second light-emitting chip 22 is about 110 μm±1 μm, as described above. Moreover, the first light-emitting chip 20 and the second light-emitting chip 22 can be positioned highly accurately in a thickness direction (Z direction). Each of the second light source 26 and the third light source 28 of the second light-emitting chip 22 is apart from a first light source 24 of the first light-emitting chip 20 by a predetermined distance L13.

The second light-emitting chip 22 being a lower layer is provided with two light sources (the second light source 26 and the third light source 28) while the first light-emitting chip 20 being an upper layer is provided with the first light source 24. End surfaces of the first and the second light-emitting chips 20 and 22 on which the first to the third light sources 24, 26, and 28 are provided face in a Y direction.

As shown in FIG. 3B, in this embodiment, a travel direction of the first laser beam 25 is corrected to be in a Z direction by use of optical correction components, and thus an optical path of the first laser beam 25 is superposed on an optical path of the second laser beam 27.

Specifically, in the course of the optical paths of the first laser beam 25 and the second laser beam 27, a first optical correction component 11 and a second optical correction component 13 are disposed in this order. Each of the first optical correction component 11 and the second optical correction component 13 has wavelength selectivity to incline the travel direction of the first laser beam 25 by diffracting the first laser beam 25, and to transmit the second laser beam 27 and the third laser beam 29 as they are, without inclining them by a diffraction effect.

Specifically, when the first optical correction component 11 diffracts the first laser beam 25 having travelled parallel to an optical axis of the optical pick-up device 30, the first laser beam 25 travels while being inclined toward the second laser beam 27 (at an angle θ3). In addition, the second optical correction component 13 diffracts the first laser beam 25 having passed through the first optical correction component 11 and thus the travelling direction of the first laser beam 25 is bent in a reverse direction, so that the first laser beam 25 travels parallel to the optical axis. An angle θ4 at which the second optical correction component 13 inclines the optical path of the first laser beam 25 is the same as the angle θ3 described above.

By employing the first and the second optical correction components 11 and 13, the optical path of the first laser beam 25 having passed through the second optical correction component 13 is superposed on the optical path of the second laser beam 27. Thus, it is possible to receive both the first laser beam 25 and the second laser beam 27 by the same first light reception region 42A of a PDIC 42. Even if the first laser beam 25 and the second laser beam 27 cannot be superposed completely on one another, both of the laser beams can be received by the single first light reception region 42A as long as the distance between them falls within 5 μm.

In this respect, each of the second light source 26 and the third light source 28 included in the second light-emitting chip 22 may be deviated in the X direction from the first light source 24 included in the first light-emitting chip 20 due to a mounting error (about ±20 μm), in FIG. 3A. In such a case, the only thing to do is to add a first optical correction component 11 and a second optical correction component 13 as shown in FIG. 3B to correct the optical path of the first laser beam 25 in the X direction toward the second laser beam 27. Since the optical path needs correction in the X direction in this case, each of the added first optical correction component 11 and the added second optical correction component 13 needs to be rotated at 90 degrees in a plane direction.

### Second Embodiment

### Method of Manufacturing Optical Pick-Up Device

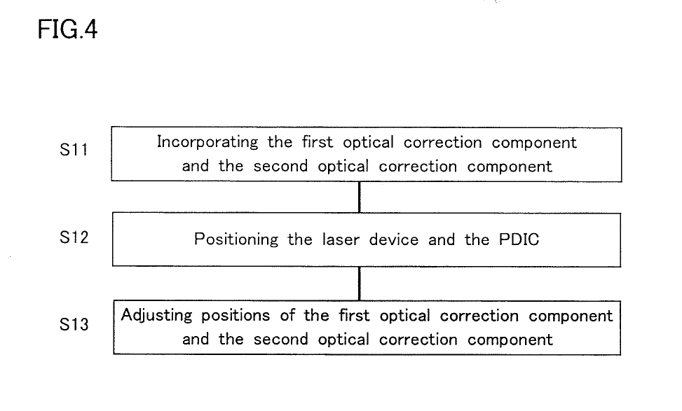

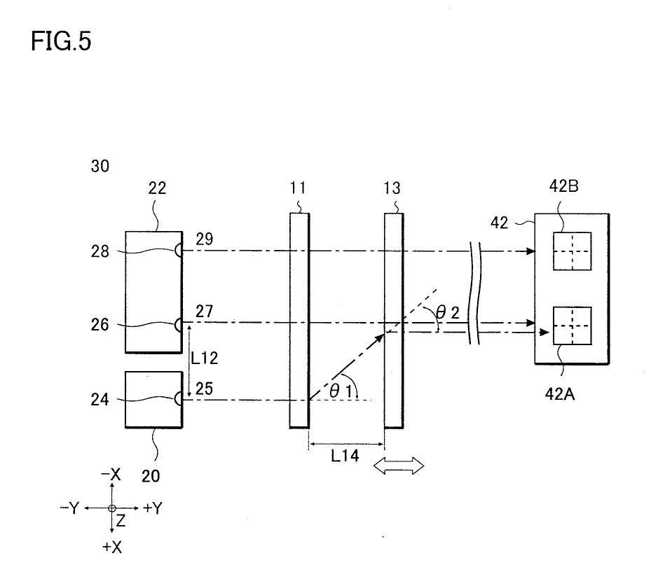

With reference to FIG. 4 and FIG. 5, a description will be given of the method of manufacturing an optical pick-up device, a configuration of which is described in the first embodiment.

As shown in FIG. 4, the method of manufacturing an optical pick-up device according to this embodiment mainly includes: Step S11 of incorporating a first optical correction component 11 and a second optical correction component 13; Step S12 of positioning optical components such as a laser device and a PDIC; and Step S13 of adjusting positions of optical correction components. In this respect, Step S13 of adjusting positions of optical correction components may be omitted on condition that the optical components are fixedly attached to the housing with such an accuracy that requires no correction.

In Step S11, firstly, the first optical correction component 11 or the second optical correction component 13 is disposed in a housing in such a manner as to be movable in a direction of an optical axis. Here, in the case of FIG. 1C, the first optical correction component 11 is fixedly attached to the housing by an adhesive agent while the second optical correction component 13 is made movable. In this case, an optical path is adjusted in a latter step by moving the second optical correction component 13.

In contrast, the optical path may be corrected by moving the first optical correction component 11, while the second optical correction component 13 is fixedly attached to the housing. Alternatively, both the first and the second optical correction components 11 and 13 may be movably incorporated in the housing, and the optical path can be corrected by moving both the first and the second optical correction components 11 and 13.

In Step S12, each optical component shown in FIG. 2 is fixedly attached to the housing. Specifically, a laser device 10, a semitransparent mirror 36, a collimate lens 34, a reflecting mirror 32, a quarter wave plate 35, an objective lens 37, a diffraction grating 31, an anamorphic lens 40, and a PDIC 42 are incorporated in predetermined positions in an optical pick-up device 30. Here, the optical components other than the first and the second optical correction components 11 and 13 are fixedly attached to the housing by an insulating adhesive such as an epoxy resin. In addition, in this step, the position of the PDIC 42 is adjusted while the position of the laser device 10 is fixed in order that laser beams emitted from the laser device 10 are appropriately incident on a light reception portion of the PDIC 42. Further, rotational adjustment of the diffraction grating 31 is made subsequently.

With reference to FIG. 5, in Step S13, the positions of the first and the second optical correction components 11 and 13 are adjusted in such a way that a first laser beam 25 emitted from a first light-emitting chip 20 is superposed on a second laser beam 27 emitted from a second light-emitting chip 22.

Specifically, as has been described above, the first light-emitting chip 20 and the second light-emitting chip 22 are arranged with a mounting error of about ±20 μm. The error differs for each laser device manufactured. For this reason, in this embodiment, a distance L14 between the first optical correction component 11 and the second optical correction component 13 is adjusted after the other optical components such as the PDIC 42 are incorporated in the housing so that the optical path of the first laser beam 25 can be corrected to a predetermined position.

Here, the first optical correction component 11 and the second optical correction component 13 are arranged in the course of the optical paths of the first to the third laser beams 25, 27, and 29. In addition, an angle θ1 at which the first optical correction component 11 inclines the first laser beam 25 is the same as an angle θ2 at which the second optical correction component 13 inclines the first laser beam 25, but the angles θ1 and θ2 direct the first laser beam 25 in opposite directions, respectively.

In addition, a distance L14 between the first optical correction component 11 and the second optical correction component 13 is calculated from the following equation using a distance L12 between a first light source 24 which emits the first laser beam 25 and a second light source 26 which emits the second laser beam 27.

L14=L12× cot(θ1)

As described above, however, the distance L12 between the first and the second light sources 24 and 26 which are provided in different light-emitting chips varies depending on the mounting error between the first light-emitting chip 20 and the second light-emitting chip 22. If the distance L14 between the first optical correction component 11 and the second optical correction component 13 is fixed, an optical pick-up device 30 involving a mounting error has a problem that the optical path of the first laser beam 25 corrected by the optical correction components is not disposed at a predetermined position.

In view of the above, in this embodiment, the distance L14 between the first optical correction component 11 and the second optical correction component 13 is adjusted after the other optical components are fixedly attached to predetermined positions of the housing.

How to adjust the distance L14 will be specifically described below. Firstly, the first laser beam 25 is emitted from the first light source 24 of the first light-emitting chip 20, with the other optical components incorporated in the housing. At the same time, an output from a first light reception region 42A of the PDIC 42 is monitored.

The distance L14 between the first optical correction component 11 and the second optical correction component 13 is determined in such a manner that the first laser beam 25 is superposed on the second laser beam 27 when the distance L12 between the first laser beam 25 and the second laser beam 27 is a predetermined length (110 μm, for example). In strict sense, however, the first laser beam 25 and the second laser beam 27 are not superposed on each other due to variation in mounting errors described above. Thus, even though the first and the second correction components 11 and 13 correct the optical path of the first laser beam 25, the first laser beam 25 is not incident on the first light reception region 42A appropriately. In other words, the first laser beam 25 is not incident on or around a center portion of the first light reception region 42A.

In Step S13, the distance L14 between the first optical correction component 11 and the second optical correction component 13 is adjusted while monitoring the output from the first light reception region 42A of the PDIC 42. As a method of adjusting the distance L14, a method is employed in which the second optical correction component 13 is shifted in the Y direction (in the +Y direction and the −Y direction) while the position of the first optical correction component 11 is fixed.

Here, the first light reception region 42A is divided into quarters of light reception region sections. The distance L14 is adjusted in such a manner that the outputs from the respective four light reception region sections become equal to one another. For example, the output from the PDIC 42 is monitored while the second optical correction component 13 is being shifted in the Y direction. The most suitable distance L14 is determined based on the corresponding position of the second optical correction component 13 at which the outputs from the respective four light reception region sections of the first light reception region 42A are as equal to one another as possible.

Once the first laser beam 25 is appropriately incident on the first light reception region 42A, the adjustment of the distance L14 is finished at this point and the second optical correction component 13 is fixedly attached to the housing by an insulating bonding agent.

The optical pick-up device 30 is manufactured according to the steps described above.

In this embodiment, the optical path of the first laser beam 25 is corrected by adjusting the distance L14 between the first optical correction component 11 and the second optical correction component 13 after the other optical components are positioned. For this reason, even in a case where the first light-emitting chip 20 which emits a laser beam is arranged with an ununiform mounting error, the error can be absorbed appropriately by use of optical correction components.

Further, in this embodiment, three laser beams emitted from different light-emitting chips can be received by the PDIC 42 which is a single semiconductor element. Specifically, the PDIC 42 includes two light reception regions (the first light reception region 42A and the second light reception region 42B), and the light reception regions are positioned in such a manner as to be able to appropriately receive the second laser beam 27 and the third laser beam 29 emitted from the second light-emitting chip 22. In this embodiment, while outputs from the first light reception region 42A of the PDIC 42 are being monitored, the distance L14 between the first optical correction component 11 and the second optical correction component 13 is adjusted in such a manner that the first laser beam 25 is appropriately incident on the first light reception region 42A. With this position adjustment, it is possible to appropriately receive a first laser beam 25 which is emitted from another light-emitting chip, i.e., the first light-emitting chip 20 on the PDIC 42 disposed by using the second light-emitting chip 22 as a reference. This eliminates the need for preparing separate PDICs for light-emitting chips provided with a mounting error. Thus, the optical pick-up device 30 requires less number of components, thereby leading to cost reduction.

Here, the method of manufacturing an optical pick-up device 30 shown in FIGS. 3A and 3B is basically the same as the above-mentioned method. The difference between these methods is that the first correction component 11 inclines the optical path of the first laser beam 25 in the Z direction. In this case, each of the first and the second optical correction components 11 and 13 needs to be arranged with rotation at 90 degrees in a plane direction, as described above.

In addition, in the description provided above, the first optical correction component 11 and the second optical correction component 13 incline the optical path of the first laser beam 25 by a diffraction effect. The optical path of the first laser beam 25, however, may be inclined by other effects. Specifically, the first optical correction component 11 and the second optical correction component 13 may incline the optical path of the first laser beam 25 with an effect of polarization selection or anomalous dispersion of a photonic crystal.

What is claimed is:

1. An optical pick-up device which emits a laser beam to an optical recording medium and detects the laser beam reflected back from the optical recording medium, the optical pick-up device comprising:
a laser device which includes a first light-emitting chip and a second light-emitting chip, the first light-emitting chip emitting a first laser beam from a first light source, the second light-emitting chip emitting a second laser beam from a second light source, the second laser beam having a wavelength different from the first laser beam;
a first optical correction component which is disposed in the course of optical paths of the first and the second laser beams, the first optical correction component inclining a travel direction of the first laser beam toward the second laser beam and transmitting the second laser beam;
a second optical correction component which is disposed in the course of the optical paths of the first and the second laser beams at a position farther from the laser device than the first optical correction component is, the second optical correction component correcting the travel direction of the first laser beam in such a way that the first laser beam travels parallel to an optical axis of the optical pick-up device, and transmitting the second laser beam; and
a light receiving chip including a first light reception region which receives the first laser beam and the second laser beam.

2. The optical pick-up device according to claim 1, wherein
in addition to the second light source, the second light-emitting chip further includes a third light source which emits a third laser beam having a wavelength different from wavelengths of the first laser beam and the second laser beam, and
the light receiving chip includes the first light reception region and a second light reception region, the first light reception region receiving the first laser beam and the second laser beam, the second light reception region receiving the third laser beam.

3. The optical pick-up device according to claim 1, wherein a distance between the first optical correction component and the second optical correction component is determined on the basis of a distance between the first light source provided in the first light-emitting chip and the second light source provided in the second light-emitting chip.

4. The optical pick-up device according to claim 1, wherein the first light source of the first light-emitting chip is arranged closer to the light receiving chip than the second light source of the second light-emitting chip is.

5. The optical pick-up device according to claim 1, wherein the first light-emitting chip and the second light-emitting chip are fixedly attached to the same mounting surface.

6. The optical pick-up device according to claim 1, wherein the first light-emitting chip is fixedly attached to an upper surface of the second light-emitting chip.

7. A method of manufacturing an optical pick-up device which emits a first laser beam and a second laser beam to an optical recording medium and detects the first and the second laser beams reflected back from the optical recording medium, the second laser beam having a wavelength different from a wavelength of the first laser beam, the method comprising:
a first step of disposing a first optical correction component in the course of optical paths of the first and the second laser beams and disposing a second optical correction component in the course of the optical paths of the first and the second laser beams at a position farther from a laser device than the first optical correction component is, the first optical correction component inclining a travel direction of the first laser beam toward the second laser beam and transmitting the second laser beam, the second optical correction component correcting a travel direction of the first laser beam in such a way that the first laser beam travels parallel to an optical axis of the optical pick-up device and transmitting the second laser beam; and
a second step of positioning the laser device and a light receiving chip, the laser device including a first light-emitting chip emitting the first laser beam from a first light source and a second light-emitting chip emitting the second laser beam from a second light source, the light receiving chip including a light reception region on which the second laser beam is incident.

8. The method of manufacturing an optical pick-up device according to claim 7, the method further comprising a third step of separating the first optical correction component and the second optical correction component apart so that the first laser beam emitted from the first light-emitting chip is incident on the light reception region of the light receiving chip.

9. The method of manufacturing an optical pick-up device according to claim 8, wherein in the third step, a distance by which the first optical correction component and the second optical correction component are separated is adjusted while an output from the light receiving chip is being measured.
